(19) United States
(12) Patent Application Publication
(10) Pub. No.: US 2011/0146641 A1
(43) Pub. Date: Jun. 23, 2011

(54) Internal Combustion Engine

(75) Inventors: Niels Kunert, Ottenbach (DE); Horst Denner, Leutenbach (DE)

(73) Assignee: ANDREAS STIHL AG & CO. KG, Waiblingen (DE)

(21) Appl. No.: 12/968,315

(22) Filed: Dec. 15, 2010

(30) Foreign Application Priority Data
Dec. 19, 2009 (DE) 10 2009 059 145.1

(51) Int. Cl. F02B 25/00; F02F 1/00

(52) U.S. Cl. 123/65 P; 123/193.2

(57) ABSTRACT

An internal combustion engine has a cylinder with cylinder liner and a reciprocatingly supported piston delimiting a combustion chamber and driving in rotation a crankshaft in a crankcase. A device for supplying fuel and combustion air is provided. At least one transfer passage connects in at least one piston position the crankcase interior with the combustion chamber. The transfer passage has a transfer port that opens into the combustion chamber and an opening that opens into the crankcase. Opening and transfer port are displaced relative to each other in circumferential direction of the cylinder. The cylinder liner has at least one segment of a piston bearing surface and forms at least one wall section of the transfer passage. The cylinder has an upper cylinder segment and a lower cylinder segment that are separately embodied. The cylinder liner is separate from the upper and lower cylinder segments.

### BACKGROUND OF THE INVENTION

The invention concerns an internal combustion engine with at least one transfer passage whose opening and transfer port are displaced in circumferential direction of the cylinder relative to each other.

In order to simplify the manufacture of internal combustion engines, it is known from AT 004 171 U1 to use a cylinder liner in the cylinder which cylinder liner delimits transfer passages relative to the cylinder interior. Outwardly, the transfer passages are delimited by the cylinder and the crankcase. Since the transfer passages of AT 004 171 U1 essentially extend parallel to the longitudinal cylinder axis, it is possible that cores that mold the transfer passages in the production of the cylinder by pressure die casting can be pulled in the direction of the longitudinal cylinder axis.

It has been found that in two-stroke engines improved scavenging results and thus better exhaust gas values are achievable when the transfer ports and the openings of the transfer passages at the crankcase are displaced in circumferential direction of the cylinder relative to each other so that the opening and the transfer port of a transfer passage are not congruently positioned on top of each other in the direction of the longitudinal cylinder axis. In case of such transfer passages that are slanted relative to the longitudinal cylinder axis it is impossible to pull the cores in the direction of the longitudinal cylinder axis.

It is the object of the present invention to provide an internal combustion engine which can be produced in a simple way.

### SUMMARY OF THE INVENTION

This object is solved by an internal combustion engine with a cylinder in which a piston is reciprocatingly supported, wherein the piston delimits a combustion chamber disposed in the cylinder, wherein the piston drives a crankshaft that is rotatably supported in a crankcase, comprising a device for supplying fuel and combustion air and comprising at least one transfer passage that connects in at least one position of the piston the interior of the crankcase with the combustion chamber and that opens with a transfer port into the combustion chamber and with an opening into the crankcase, wherein the opening and the transfer port in the circumferential direction of the cylinder are displaced relative to each other, wherein the cylinder has a cylinder liner arranged therein in which at least one segment of the piston bearing surface is formed and which forms at least one wall section of at least one transfer passage and wherein the cylinder has an upper cylinder segment and a lower cylinder segment that are embodied separate from each other and separate from the cylinder liner.

Since the cylinder is separated into an upper cylinder segment and a lower cylinder segment, the transfer passages can be formed by means of several cores when producing the cylinder by pressure die casting. The cores that form or mold the upper part of the transfer passage segments embodied in the lower cylinder segment can be removed upwardly in the direction of the combustion chamber. At the dividing plane between the upper one and the lower one of the cylinder segments there are additional possible removal directions which enable the manufacture of a cylinder with spirally extending transfer passages around the longitudinal cylinder axis by pressure die casting; this is made possible without mandatorily requiring additional lids, inserts or the like. In order to have additional degrees of freedom in the production of the cylinder, additional lids, inserts or the like may however be advantageous.

It is provided that the upper cylinder segment and the lower cylinder segment adjoin each other at a transverse dividing plane, in particular a dividing plane extending perpendicularly to the longitudinal cylinder axis. The cylinder liner projects advantageously at least up to the lower edge of all transfer ports, which lower edge is facing the crankcase. In this connection, the cylinder liner extends from the side of the cylinder facing the crankcase into the cylinder. In this way, the cylinder liner forms about the entire length of the transfer passages embodied in the cylinder a wall segment of the transfer passages. The transfer passages can be embodied in the cylinder as inwardly open channels and are sealed by the cylinder liner toward the cylinder interior. In this way, a simple production and great design freedom result with respect to the design of the transfer passages. It may also be provided that the cylinder liner has depressions at its outer circumference which delimit the transfer passages, and that the cylinder bore is embodied at least partially as a smooth-walled bore. Expediently, the cylinder liner ends at the lower edge of the transfer port. The cylinder liner is thus embodied as a partial cylinder liner that does not extend about the entire piston bearing surface. Since the cylinder liner is positioned at the lower edge of the transfer port, no cutouts or openings are necessary for the transfer ports within the cylinder liner. Advantageously, the entire contour of the transfer passages is embodied in the cylinder and in the crankcase so that the cylinder liner can be embodied as a smooth tube. Expediently, the cylinder liner is pressed into the upper cylinder segment from the side facing the crankcase.

The upper cylinder segment is embodied advantageously as a separate component. The lower cylinder segment can be embodied as a component separate from the crankcase. The internal combustion engine is thus comprised of an upper cylinder segment and a lower cylinder segment, one or several crankcase components as well as a cylinder liner. In this connection, advantageously the transfer passage is intersected between the transfer port and the opening by at least two dividing planes. Therefore, in the area of the transfer passage there extend at least two dividing planes. Enough degrees of freedom can be created in this way for pulling the cores in the manufacture of the internal combustion engine.

However, it may also be advantageous that the lower cylinder segment is integrally formed on at least one crankcase component. With a multi-part crankcase the lower cylinder segment may also be of a multi-part embodiment so that a part of the lower cylinder segment is thus integrally formed on a crankcase component, respectively. In particular, the crankcase has two crankcase half shells which have a joining plane extending parallel to the longitudinal cylinder axis. In this case a part of the lower cylinder segment can be integrally formed on each crankcase half shell, respectively.

An excellent combustion chamber scavenging action results when transfer port and opening of at least one transfer passage have a distance in circumferential direction of the cylinder relative to each other. Even transfer passages where displacement between transfer ports and openings is so big that a spacing in circumferential direction results can thus be molded by means of pressure die casting with cores as a result of the suggested division of the cylinder into an upper cylinder segment and a lower cylinder segment. In particular, at least one transfer passage extends relative to the longitudinal cylinder axis in a spiral shape. The transfer passage extends advantageously at a slant to the longitudinal cylinder axis as well as to a plane perpendicular to the longitudinal cylinder axis about its entire length embodied in the cylinder.

It is provided that the internal combustion engine has a mixture inlet and an outlet and the cylinder has a center plane which divides the mixture inlet and the outlet wherein on each side of the center plane at least two transfer ports open into the combustion chamber. In particular, the transfer passages whose transfer ports are arranged on a common side of the center plane open with a common opening into the interior of the crankcase. The transfer passages whose transfer ports are arranged on a common side of the center plane are expediently embodied in the upper cylinder segment separate from each other and in the lower cylinder segment form together a common channel segment. A simple manufacture is provided because the dividing plane between the cylinder segments extends at the level where the transfer passages are combined. In particular, a first transfer passage whose transfer port is arranged on a first side of the center plane and a second transfer passages whose transfer port is arranged on an oppositely positioned second side of the center plane open with a common opening into the interior of the crankcase. Therefore, transfer passages of opposite sides of the cylinder are combined and open with a common opening into the crankcase. In particular, all transfer passages open with a common opening into the interior of the crankcase.

The cylinder has advantageously cooling ribs and is air-cooled.

### BRIEF DESCRIPTION OF THE DRAWINGS

Embodiments of the invention are explained in the following with the aid of the drawing.

FIG. 1 is a schematic side view of a motor chain saw.

FIG. 2 is a schematic section view of the chain saw of FIG. 1.

FIG. 3 is a schematic section illustration of the internal combustion engine of the motor chain saw.

FIG. 4 is a schematic perspective section illustration of an embodiment of an internal combustion engine.

FIG. 5 is a schematic illustration of a developed course of the transfer passages of the internal combustion engine of FIG. 4.

FIG. 6 is a schematic longitudinal section of a transfer passage.

FIG. 7 shows a section along the line VII-VII in FIG. 6.

FIG. 8 shows a schematic illustration of an embodiment of transfer passages.

FIG. 9 is an exploded view of an embodiment of the cylinder of an internal combustion engine.

FIG. 10 is a section view of the cylinder of FIG. 9.

FIG. 11 is a view from below of the upper cylinder segment of the cylinder of FIG. 10 in the direction of the arrow XI in FIG. 10.

FIG. 12 is a perspective illustration of the lower cylinder segment.

FIG. 13 is a view of the lower cylinder segment of the side facing the upper cylinder segment.

FIG. 14 a view of the lower cylinder segment of the side facing the crankcase.

FIG. 15 is an exploded view of an embodiment of a cylinder and crankcase.

### DESCRIPTION OF PREFERRED EMBODIMENTS

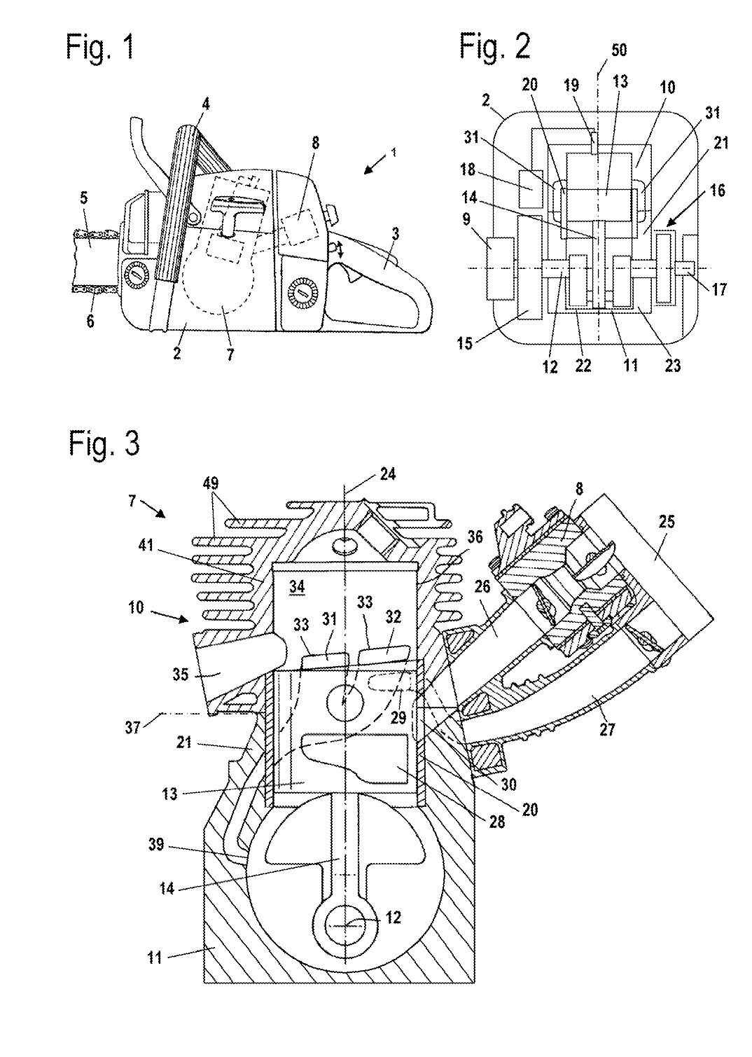

In FIG. 1 a motor chain saw 1 is shown as an embodiment of a hand-guided power tool in which an internal combustion engine according to the invention can be used. However, the internal combustion engine according to the invention can be used, for example, also in other hand-guided power tools such as cut-off machines, trimmers, lawn mowers or the like. The motor chain saw 1 has a housing 2 to which a rear handle 3 and a handle pipe 4 are secured. On the side of the housing 2 that is facing away from the rear handle 3 a guide bar 5 extends forwardly on which a saw chain 6 is arranged so as to circulate. The saw chain 6 is driven by an internal combustion engine 7 to which fuel and combustion air are supplied by a carburetor 8.

As schematically shown in FIG. 2, the internal combustion engine 7 has a cylinder 10 in which a piston 13 is reciprocatingly supported as well as a crankcase 11. The piston 13 drives by means of a connecting rod 14 a crankshaft 12 that is rotatably supported in the crankcase 11. On the crankshaft 12 a fan wheel 15 is secured for common rotation. On the outer circumference of the fan wheel 15 an ignition module 18 is provided that supplies ignition energy to the spark plug 19 projecting into the cylinder 10. Moreover, on the crankshaft 12 a starter device 9 is fixedly secured. On the opposite side of the crankcase 11 a clutch 16 is arranged on the crankshaft 12 and connects the crankshaft 12, after a coupling speed has been surpassed, with a drive pinion 17 that drives the saw chain 6.

As shown in FIG. 2, the cylinder 10 has an upper cylinder segment 41 and a lower cylinder segment 21 that is integrally formed with the crankcase 11. The crankcase 11 is comprised of two crankcase half shells 22 and 23 on which a section of the lower cylinder segment 21 is integrally formed, respectively. A cylinder liner 20 is pressed into the cylinder 10 from the side facing the crankcase 11. The cylinder liner 20 delimits transfer passages 31, shown schematically in FIG. 2, toward the cylinder interior. The cylinder 10 has a center plane 50 relative to which the transfer passages 31 are arranged mirror-symmetrically.

In FIG. 3 the internal combustion engine 7 is shown in detail. The internal combustion engine 7 is embodied as a single cylinder two-stroke engine that works with scavenging air. The internal combustion engine 7 has a mixture channel 26 for supplying fuel/air mixture and an air duct 27 that supplies the combustion air or lean mixture to the transfer passages 31, 32. The mixture channel 26 and the air duct 27 are connected with an air filter 25 through which combustion air is sucked in. The mixture channel 26 opens with a mixture inlet 30, piston-controlled by the piston 13, into the crankcase 11. The air duct 27 branches in the area of the connection flange of the internal combustion engine 7 into two branches that each open with an air intake 29 at the piston bearing surface 36. The piston 13 has on each side a piston recess 28 that connects an air intake 29 in the area of the top dead center of the piston 13 with the transfer port 33 of the transfer passages 31, 32, respectively, so that combustion air poor in fuel is supplied to the transfer passages 31, 32.

In the cylinder 10 a combustion chamber 34 is embodied that is delimited by the piston 13 and provided with an outlet 35. FIG. 2 shows a center plane 50 that divides the outlet 35 and the mixture inlet 30. On each side of the center plane 50, a transfer passage 31 close to the outlet 31 and a transfer passage 32 remote from the outlet are provided which open with transfer ports 33 into the combustion chamber 34. The transfer passages 31, 32 are combined within the lower cylinder segment 21 and open with a common opening 39 into the interior of the crankcase 11. The opening 39 is arranged below the outlet 35.

The transfer passages 31, 32 extend about a longitudinal cylinder axis 24 in a spiral shape. In order to be able to produce these transfer passages 31, 32 by pressure die casting with pull cores, the cylinder 10 is of a divided configuration. The cylinder 10 has thus an upper, separately embodied, cylinder segment 41 and a lower cylinder segment 21 that is integrally formed on the crankcase 11. Both cylinder segments 21 and 41 adjoin each other at the dividing plane 37 that extends perpendicularly to the longitudinal cylinder axis 24, as shown in FIG. 3. As shown also in FIG. 3, the upper cylinder segment 41 has cooling ribs 49 across which the air conveyed by the fan wheel 15 streams so that air cooling of the internal combustion engine 7 is provided.

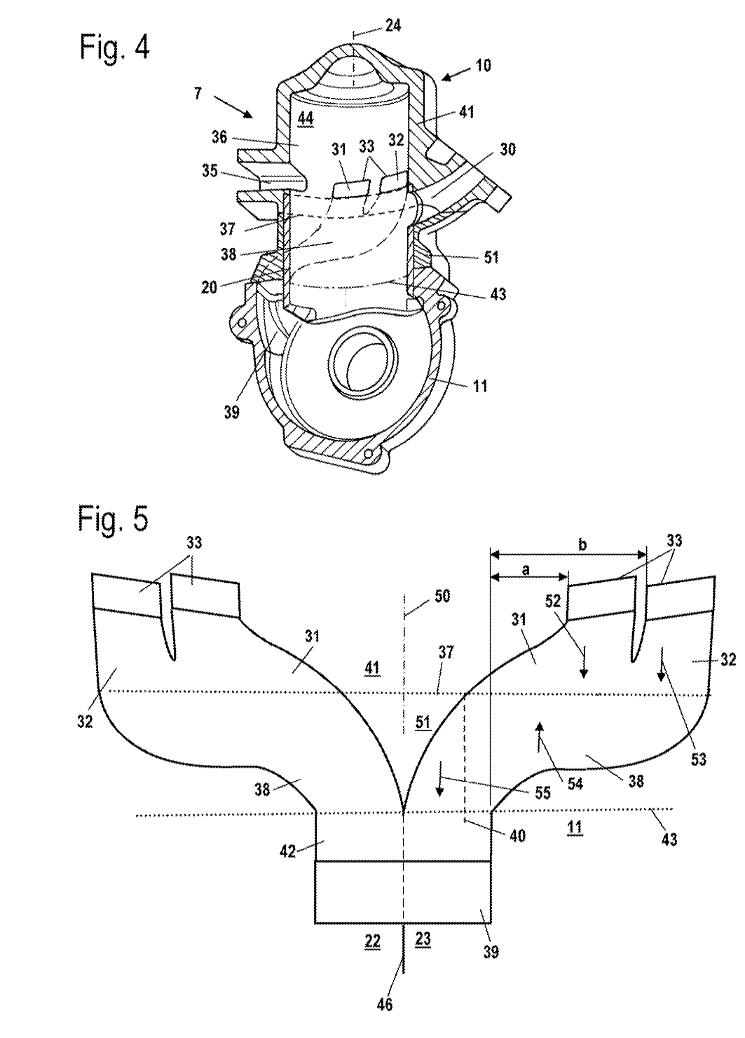

FIG. 4 shows an embodiment of an internal combustion engine 7 which works without scavenging air and has, therefore, no air duct 27. At the cylinder 10 only a mixture inlet 30 opens that is controlled by the piston 30. As shown in FIG. 4, the cylinder 10 is embodied of a two-part configuration and has an upper cylinder segment 41 and a separate, lower cylinder segment 51. The cylinder liner 20 is pressed into both cylinder segments 41, 51 from the side facing the crankcase 11. The crankcase 11 is embodied as a component separate from the lower cylinder segment 51. The crankcase 11 can be comprised advantageously of two crankcase half shells that are divided in the direction of a plane that is parallel to the longitudinal cylinder axis 24 and perpendicular to the axis of rotation of the crankshaft 12. The lower cylinder segment 51 is positioned in a dividing plane 43 at the upper edge of the crankcase 11. As shown in FIG. 4, the cylinder liner 20 forms a part of the piston bearing surface 36 and projects from the end of the piston bearing surface 36 facing the crankcase to a point below the transfer port 33. Both dividing planes 37 and 43 intersect the transfer passages 31 and 32 between the transfer port 33 and the opening 39.

FIG. 5 shows schematically the course of the transfer passages 31 and 32. The transfer passages 31 and 32 are shown in a developed view. On each side of the center plane 50 there are two transfer passages 31 and 32. The transfer passages 31 and 32 extend within the upper cylinder segment 41 separate from each other and in the lower cylinder segment 51 are combined in a common passage segment 38. In the area of the dividing plane 43 relative to the crankcase 11 the common segments 38 that extend on each side of the center plane 50 are combined to a common segment 42 of all transfer passages 31 and 32. All transfer passages 31 and 32 open with a common opening 39 into the interior of the crankcase 11. The opening 39 is arranged below the outlet 35 (FIG. 4).

As shown in FIG. 5, the transfer port 33 of the transfer passage 31 is spaced at a s spacing a from the opening 39 measured in the circumferential direction and the transfer port 33 of the outlet-remote transfer passage 32 is spaced at a distance b from the opening 39. Between the transfer ports 33 and the opening 39 the transfer passages 31 and 32 extend at a slant relative to the longitudinal cylinder axis 24 and in a spiral shape around the longitudinal cylinder axis 24.

On account of this spirally shaped course it is not possible to produce the transfer passages by pressure die casting with pull cores when the upper cylinder segment 41 and the lower cylinder segment 51 are embodied of a one-piece configuration, i.e, as a common component. By means of the dividing plane 37 molding of the transfer passages 31 and 32 with pull cores is possible. For this purpose, a direction of pull 52 is provided for the core that is arranged in the outlet-near transfer passage 31 in the upper cylinder segment 41 and a direction of pull 53 for the core in the transfer passage 32. The directions of pull 52 and 53, shown schematically in FIG. 5, extend parallel to the longitudinal cylinder axis 24 and in the direction of the crankcase 11. It may also be provided that the directions of pull 52 and 53 extend at a slant to the longitudinal cylinder axis 24. In order to mold the common passage segment 38 a core is provided that is pulled in a direction of pull 54 in the direction toward the combustion chamber 34 and a second core that is pulled in a direction of pull 55 in the direction toward the crankcase 11. Both cores have a dividing line 40 where the two cores adjoin. The dividing line 40 can extend parallel to the longitudinal cylinder axis 24. The molded segment 42 in the crankcase 11 can be molded perpendicularly to a joining plane 46 between the crankcase half shells 22 and 23. The directions of pull 52 to 55 and the position of the dividing plane 37 are selected such that no undercuts exist when pulling the cores. In this connection, the length of the cylinder liner 20 and the position of the dividing plane 37 are to be selected depending on the design of the transfer passages 31, 32 in such a way that at least three removal directions result.

When the lower cylinder segment 21 is integrally formed on the crankcase 11, the direction of pull 55 is eliminated. For a joining plane 46 of the crankcase half shells 22 and 23, the core arranged in this area can be pulled perpendicularly to the joining plane 46. The joining plane 46 extends parallel to the longitudinal cylinder axis 24 and coincides advantageously with the center plane 50. In this way, it is possible in a simple way to produce the internal combustion engine 7 of the configuration shown in FIG. 3 by pressure die casting.

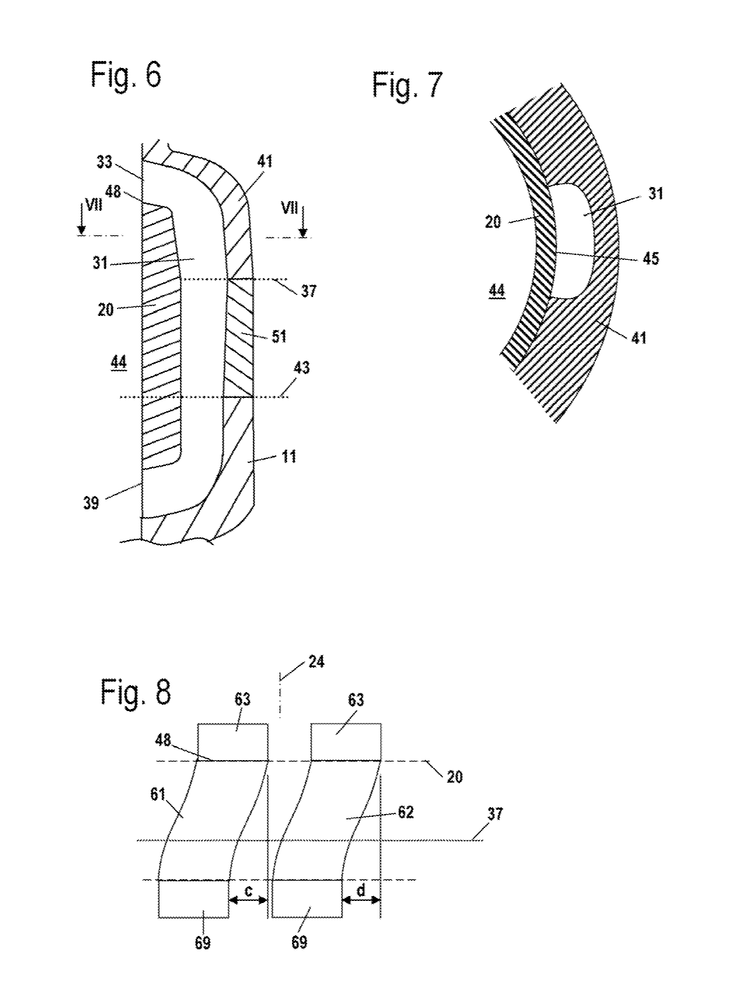

As shown in FIGS. 6 and 7, the cylinder liner 20 delimits the transfer passage 31 toward the cylinder interior 44. The cylinder liner 20 forms the inner wall of the transfer passage 31 and likewise also of the transfer passage 32. The cylinder liner 20 is provided with an integrally formed contour which causes a good course of the flow in the transfer passage 31 and accordingly also in the transfer passage 32. In this connection, the contour is advantageously the same about the entire circumference of the cylinder liner 20 so that a rotation-symmetrical shape of the cylinder liner 20 results. However, the cylinder liner 20 can also have a cylindrical contour delimiting the transfer passages 31, 32. As shown in FIG. 6, the cylinder liner 20 projects up to the lower edge 48 of the transfer port 33. In this connection, the edge 48 is the edge of the transfer port 33 that is facing the crankcase 11. As shown in FIG. 3, the upper edge of the cylinder liner 20 can extend at a slant to the longitudinal cylinder axis 24 when the transfer port 33 is displaced in the vertical direction. Also, a stepwise or another irregular course may be suitable. As shown in FIG. 7, the cylinder liner 20 forms a wall segment 45 of the transfer passages 31.

FIG. 8 shows an embodiment for the transfer passages 61 and 62 that extend at a slant to the longitudinal cylinder axis 24. The transfer passages 61 and 62 open with transfer ports 63 into the combustion chamber 34 and with openings 69 into the crankcase 11. The cylinder liner 20 that is schematically shown in FIG. 8 projects up to the lower edge 48 of the transfer port 63. The transfer ports 63 have relative to the openings 69 a displacement c, d. In this connection, the openings 69 and the transfer ports 63 overlap when viewed in the direction of the longitudinal cylinder axis 24 so that no spacing is present between the openings. For this inclined course the division of the cylinder into an upper and a lower cylinder segment along a dividing plane 37 is suitable also.

The design of the internal combustion engine 7 according to the invention can be also suitable in connection with an internal combustion engine 7 where on each side of the center plane 50 a transfer passage is arranged that is slanted relative to the longitudinal cylinder axis 24; in particular, it extends around it in a spiral shape.

As shown in the Figures, the transfer passages 31, 32 like the transfer passages 61 and 62 are delimited outwardly, i.e., in direction away from the cylinder interior 44, by the cylinder segments 41, 21 and 51 as well as the crankcase 11. Separate components like lids, inserts or the like for delimiting the transfer passages 31, 32, 61 and 62 are not provided. However, they may be expedient. Advantageously, separate components are not necessary for the limitation of the transfer passages on account of the cylinder liner 20 and the division of the cylinder 10 into two segments 21, 41, 51. Dividing the cylinder 10 into two segments 21, 41, 51 does not result in a restriction of the length of the transfer passages 31, 32, 61, 62. They may extend to a point below the bearing seats of the crankshaft bearings in the crankcase 11.

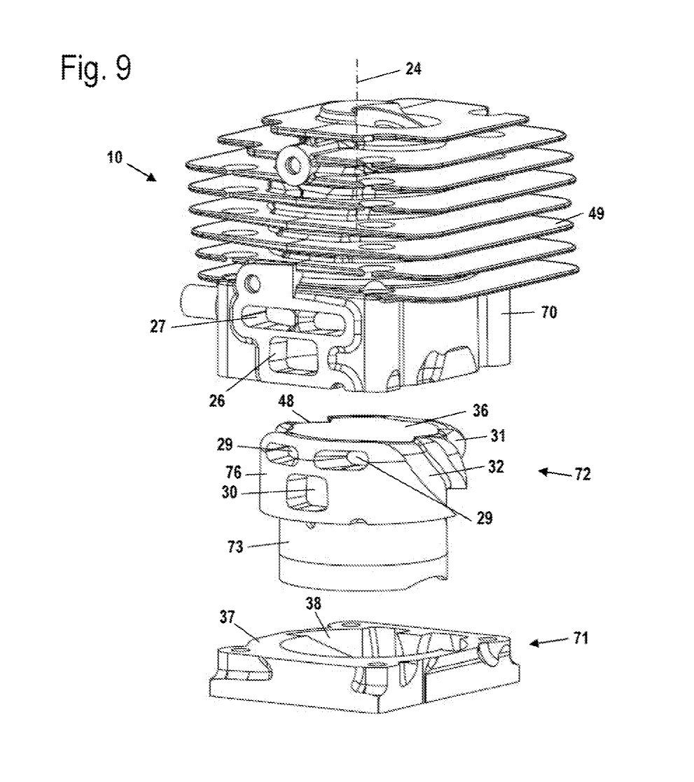

FIG. 9 shows an embodiment of a cylinder 10 which encompasses an upper cylinder segment 70 and a lower cylinder segment 71. A cylinder liner 72 is pressed into the cylinder 10. The cylinder liner 72 has an upper segment 76 arranged in the upper cylinder segment 70. On the outer side of the segment 76 the transfer passages 31 and 32 are formed as depressions. In this connection, the inner wall facing the cylinder interior as well as the side walls of the transfer passages extending in the circumferential direction are completely molded in the cylinder liner 72. The cylinder liner 72 ends approximately at the length of the lower edge 48 of the transfer ports. The cylinder 10 is a cylinder for a two-stroke engine working with scavenging air and has a mixture channel 26 and an air duct 27 which branches in the area of the cylinder flange into two branches. On the cylinder liner 72 two air intakes 29 and the mixture inlet 30 are embodied. The connection between the mixture inlet 30 and the mixture channel 26 or between the air intakes 29 and the air duct 27 are formed by openings in the cylinder liner 72.

The lower cylinder segment 71 is embodied approximately disk-shaped and has a dividing plane 37 that is perpendicular to the longitudinal cylinder axis 24 where it adjoins the upper cylinder segment 70. In the lower cylinder segment 71 the common segments 38 of the transfer passages 31 and 32 extend to the area below the outlet of the cylinder 10. The lower cylinder segment 71 is penetrated by a smooth-walled segment 73 of the cylinder liner 72. The inner wall of the transfer passages 31, 32 facing the cylinder interior is partially delimited by the lower cylinder segment 71.

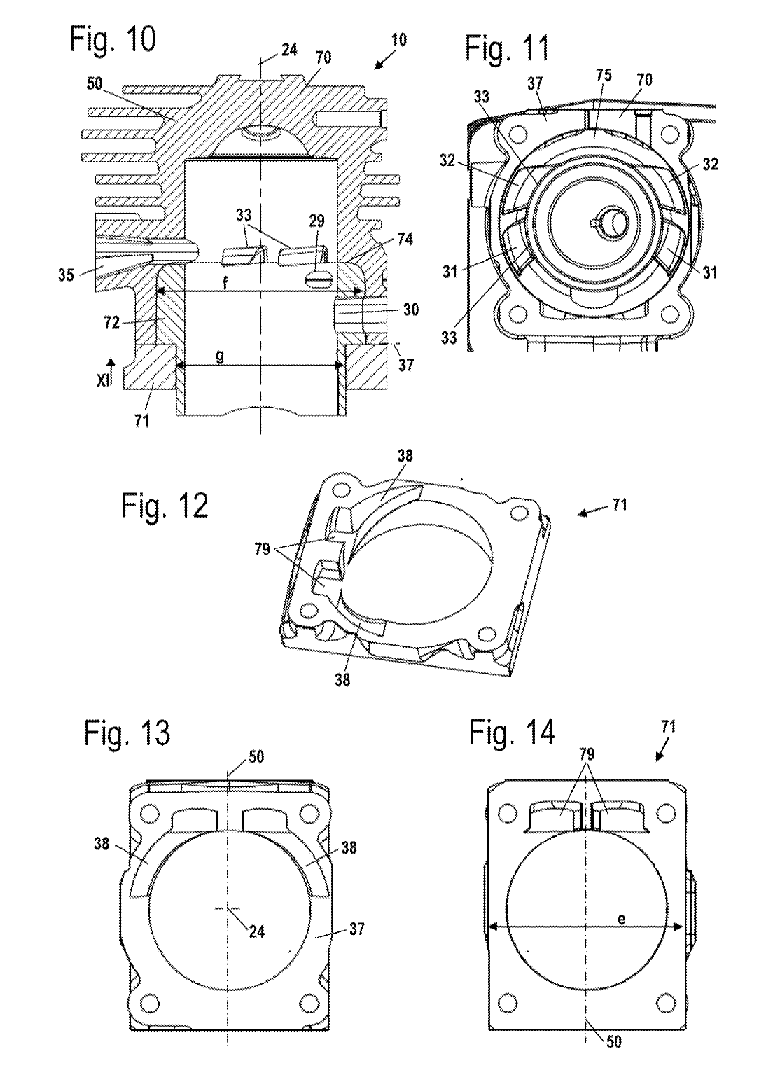

As shown in the section view of FIG. 10, the external diameter f of the cylinder liner 72 is clearly bigger than the inside diameter g of the lower cylinder segment 71. The cylinder liner 72 is secured by means of the lower cylinder segment 71 in the cylinder 10. As also shown in FIG. 10, the cylinder liner 72 has a shoulder 74 on the side that is facing the combustion chamber; this shoulder 74 is resting against the step 75 of the upper cylinder segment 70. The shoulder 74 passes with a curvature into the outer wall of the cylinder liner 72.

As shown in FIG. 11, the upper cylinder segment 70 is embodied smooth-walled from the dividing plane 37 to approximately the level of the step 75. Above the step 75 the transfer passages 31 and 32 together with the adjoining transfer ports 33 are formed as depressions in the step 75.

FIGS. 12 to 14 show the design of the lower cylinder segment 71 in detail. In the lower cylinder segment 71 the transfer passages 31 and 32 are joined in a common passage segment 38 in the area below the outlet 35. The transfer passages 31, 32 open with two separate openings 79 into the crankcase.

The cylinder liner 72 can be produced also by pressure die casting with pull cores because of the illustrated dividing plane 37 between the upper cylinder segment 70 and the lower cylinder segment 71. The lower cylinder segment 71 can also be produced by pressure die casting. The lower cylinder segment 71 has a smallest width e that is measured perpendicularly to the center plane 50 that is advantageously smaller than the external diameter f of the cylinder liner 72. In this connection, the center plane 50 is the section plane of FIG. 10 and divides the mixture inlet 30 and the outlet 35. The cylinder 10 can thus be embodied so as to be very narrow at its cylinder bottom area. As shown in FIGS. 12 to 14, the lower cylinder segment 71 is widened somewhat at the dividing plane 37 so that the lower edge of the cylinder liner 72 is covered completely by the lower cylinder segment 71. A good sealing action is thereby achieved.

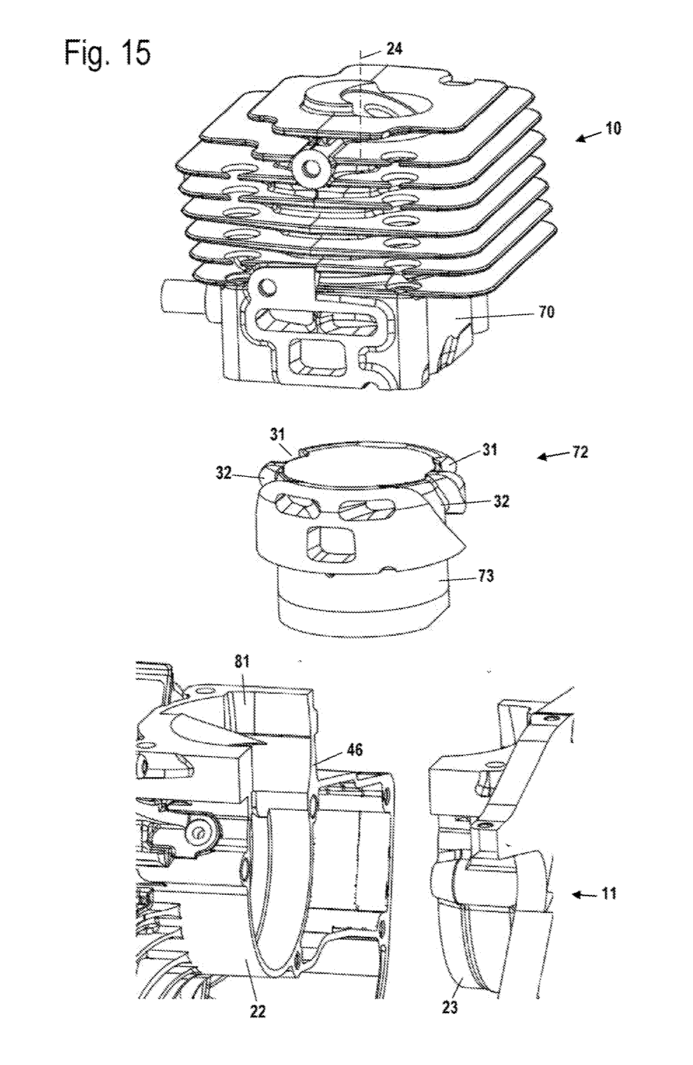

The embodiment of FIG. 15 shows an appropriate upper cylinder segment 70 and an appropriate cylinder liner 72. In this connection, same elements are referenced with same reference numerals. In the embodiment of FIG. 15 a lower cylinder segment 81 is provided that is integrally formed on the crankcase 11. The crankcase 11 is formed of two crankcase half shells 22 and 23 that are connected at a joining plane 46 with each other. The crankcase half shells 22 and 23 are also producible by pressure die casting and the cores for producing the crankcase 11 are pulled in the direction of the axis of rotation of the crankshaft 12. The number of required individual parts can be reduced in this way.

The specification incorporates by reference the entire disclosure of German priority document 10 2009 059 145.1 having a filing date of Dec. 19, 2009.

While specific embodiments of the invention have been shown and described in detail to illustrate the inventive principles, it will be understood that the invention may be embodied otherwise without departing from such principles.

What is claimed is:

1. An internal combustion engine comprising:
a cylinder with a cylinder liner;
a piston reciprocatingly supported in said cylinder and delimiting a combustion chamber disposed in said cylinder;
a crankshaft rotatably supported in a crankcase, wherein said piston drives said crankshaft;
a device for supplying fuel and combustion air;
a transfer passage that connects in at least one position of said piston an interior of said crankcase with said combustion chamber, wherein said transfer passage has a transfer port that opens into said combustion chamber and an opening that opens into said crankcase;
wherein said opening and said transfer port in a circumferential direction of said cylinder are displaced relative to each other;
wherein said cylinder liner comprises at least one segment of a piston bearing surface of said cylinder;
wherein said cylinder liner forms at least one wall section of said transfer passage; and
wherein said cylinder comprises an upper cylinder segment and a lower cylinder segment, wherein said upper and lower cylinder segments are separately embodied and wherein said cylinder liner is separate from said upper and lower cylinder segments.

2. The internal combustion engine according to claim 1, wherein said upper and lower cylinder segments adjoin each other at a dividing plane that extends transversely to a longitudinal cylinder axis of said cylinder.

3. The internal combustion engine according to claim 2, wherein said dividing plane extends perpendicularly to said longitudinal cylinder axis.

4. The internal combustion engine according to claim 1, wherein several of said transfer passage are provided and wherein said cylinder liner extends at least to a lower edge of said transfer port of all of said transfer passages, said lower edge facing said crankcase.

5. The internal combustion engine according to claim 4, wherein said cylinder liner ends at said lower edge.

6. The internal combustion engine according to claim 1, wherein said cylinder liner is pressed into said upper cylinder segment from a side of said cylinder that is facing said crankcase.

7. The internal combustion engine according to claim 1, wherein said upper cylinder segment is a separate component.

8. The internal combustion engine according to claim 1, wherein said lower cylinder segment is embodied as a component that is separate from said crankcase.

9. The internal combustion engine according to claim 8, wherein said at least one transfer passage is intersected by at least two dividing planes.

10. The internal combustion engine according to claim 1, wherein said lower cylinder segment is integrally formed on at least one component of said crankcase.

11. The internal combustion engine according to claim 1, wherein said crankcase comprises two crankcase half shells that have a joining plane that extends parallel to a longitudinal cylinder axis of said cylinder.

12. The internal combustion engine according to claim 1, wherein said transfer port and said opening of said transfer passage in said circumferential direction of said cylinder have a spacing relative to one another.

13. The internal combustion engine according to claim 1, wherein said transfer passage extends spirally relative to a longitudinal cylinder axis of said cylinder.

14. The internal combustion engine according to claim 1, comprising a mixture inlet and an outlet and wherein said cylinder has a center plane that divides said mixture inlet and said outlet, wherein several of said transfer passages are provided and on each side of said center plane at least one of said transfer ports of said transfer passages opens into said combustion chamber.

15. The internal combustion engine according to claim 14, wherein on each side of said center plane at least two of said transfer ports open into said combustion chamber and wherein said transfer passages whose transfer ports open on a same side of said center plane into said combustion chamber have a common opening that opens into an interior of said crankcase.

16. The internal combustion engine according to claim 14, wherein on each side of said center plane at least two transfer ports open into said combustion chamber and wherein said transfer passages whose transfer ports open on a same side of said center plane into said combustion chamber extend within said upper cylinder segment separate from each other and within said lower cylinder segment extend within a common passage segment.

17. The internal combustion engine according to claim 14, wherein a first one and a second one of said transfer passages are provided, wherein said first transfer passage that opens with said transfer port on a first side of said center plane and said second transfer passage that opens with said transfer port on an opposite second side of said center plane open with a common opening into an interior of said crankcase.

18. The internal combustion engine according to claim 1, wherein several of said transfer passage are provided and all of said transfer passages open with a common opening into an interior of said crankcase.

19. The internal combustion engine according to claim 1, wherein said cylinder has cooling ribs and is air-cooled.
